(19) United States
(12) Patent Application Publication
(10) Pub. No.: US 2007/0258374 A1
(43) Pub. Date: Nov. 8, 2007

(54) Scheduling by a Fraction of Remaining Time to be Allocated Over Remaining Service Interval

(75) Inventors: Amjad Soomro, Hopewell Junction, NY (US); Ruediger Schmitt, Maplewood, NJ (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,475

(22) PCT Filed: Jun. 10, 2005
(86) PCT No.: PCT/IB05/51934

§ 371 Date: Dec. 12, 2006

Related U.S. Application Data
(60) Provisional application No. 60/579,942, filed on Jun. 15, 2004.

(51) Int. Cl. H04J 3/14

(52) U.S. Cl. 370/235

(57) ABSTRACT

A method of scheduling by a fraction of remaining time to be allocated over a remaining service interval, wherein with respect to a minimum of delay bound or a maximum service interval for a traffic stream, servicing first a particular stream “i” with the highest ratio of the remaining channel time to be allocated in a service period S_{P} to the remaining time is to be serviced first before the service period S_{P} elapses. The sub-steps include (a) obtaining a factor U; for each particular traffic stream i of a plurality of traffic streams, wherein U, for each particular traffic stream I of a plurality of traffic streams, wherein (equation I), otherwise Uᵢ=1, wherein Tⁱₐᵣ is equal to remaining time to be allocated, and Tⁱ_{dr} is equal to time before an initial Service period Sⁱₚ including at least one of a Delay Bound and a Maximum Service Interval elapses; (b) selecting a particular Uᵢ factor obtained in step (a) that has a maximum value of the plurality of streams; and (c) servicing the particular stream selected in step (b) by providing channel access time.

The present invention relates to sharing a communications channel in wireless communications. More particularly, the present invention relates to allocation of time to devices communicating under a protocol such as 802.11e.

The term “user fairness” relates to the distribution of network resources among a plurality of users. In particular, bandwidth allocations can have many desirable effects to reduce/eliminate congestion on wireless networks. There are different ways that resources can be allocated in the interest of fairness. Proportional fairness and “Max min” fairness are two such methods to allocate resources.

With regard to max min fairness, there is an allocation of resources as equally as possible among competing entities. Max min fair allocations are such that they tend to favor the slower or less efficient entities, as such entities often receive more of a portion of the bandwidth than their more efficient counterparts.

With regard to proportional fairness, a maximized overall performance of the network is stressed, rather than quality in the allocation of resources. When proportional fairness is being used, the slower or less efficient entities can have their resource allocation decreased if the overall usage of the network is maximized by allocating more resources to more efficient entities.

It should be noted that both max min fairness and proportional fairness can be weighted. The goal of weighted proportional fairness is an attempt to maximize the overall performance when some of the entities have unequal parameter values, wherein such parameter values can be a set of parameters or some predefined network parameters, and still permit the less efficient or slower users to have a fair share of network resources.

User Fairness in particular is a concept used to allocate bandwidth in the case of entities having multiple pathways. Thus a group of entities can have similar allocations of bandwidth, but some of them may have the bandwidth diversified across several paths. In such situations, allocations per entity can be fair but concentrated on a specific path or paths.

In the case of wireless communications complying with protocols such as 802.11e, the fairness concept is applied to the transmission of packets. Although wired networks utilize Packet Fair Queueing algorithms, such types of algorithms simply do not function properly if used with wireless communications. One main reason has to do with the mobility of entities in a wireless network. The movement of the devices inside (or even outside) the range of the network can introduce what are referred to as “location-dependent” errors. Such errors are not always predictable, and the amount of retries, or retransmissions due to the location-dependent errors are not factored into the Packet Fair Queueing (PFQ) algorithms of wired networks. The allocations of network resources in the wired networks utilizing PFQ's were not designed with different degrees of location-dependent errors, and the entities for the most part are stationary. Thus, both fairness and delay-guarantees can be adversely affected.

There have been attempts at solving the aforementioned problems. In one article, entitled “Packet Fair Queueing Algorithms for Wireless Networks with Location-Dependent Errors” by T. S. Eugene Ng, Ion Stoica, and Hui Zhang, IEEE IFOCOM 1998, Conference on Computer Communications, No. 1, April 1998, pp. 1103-1111, which is hereby incorporated by reference as background material, an algorithm is proposed that identifies a set of properties referred to as “Channel-Condition Independent Fair” (CIF) that adapt a wired Packet Fair Queueing Algorithm for a wireless environment.

However, the attempts to provide fair queuing have not solved the problems associated with allocating packets in a wireless environment. One problem is that the previous attempts to provide fair queuing assumed that the channels have a fixed transmission rate.

In reality, the wireless channel(s) is dynamic and the channel PHY rate could vary over time and could be different for each station. This possibility of variance makes it difficult to provide both delay guarantees and fairness simultaneously. Thus, the previous attempts in the art fail to address the condition when the actual PHY rates fall below the agreed rates.

There have also been attempts at time fair weighted fair queuing (TF-WFQ) that introduces the concept of time TF-WFQ, wherein the affects of bad channel conditions are restricted to the only the “badly behaved” stations. In other words, the stations with good channels continue to operate with adjustment. Thus there is no teaching how to restrict allocated times to traffic streams such that the delay requirements are not violated. Furthermore, simply stopping the service to a stream is not desirable in bad channel conditions, as a graceful degradation of service is preferable to complete stoppage.

The present invention provides, inter alia, a solution to many of the above-mentioned problems in wireless communications. The present invention utilizes the Time Fairness concept with an algorithm that specifies a way to distribute the time allocation in such a way that the delay requirements of all streams are not violated. In addition, the invention meets QoS requirements of IEEE 802.11e for a QAP for the time allocation for servicing admitted streams.

According to an aspect of the present invention, with respect to a minimum of Delay Bound or a Maximum Service interval for a traffic stream, the channel access is allocated to a stream with the highest ratio of the remaining channel time to be allocated in a service period Sₚ to the remaining time is to be serviced first before the service period Sₚ elapses.

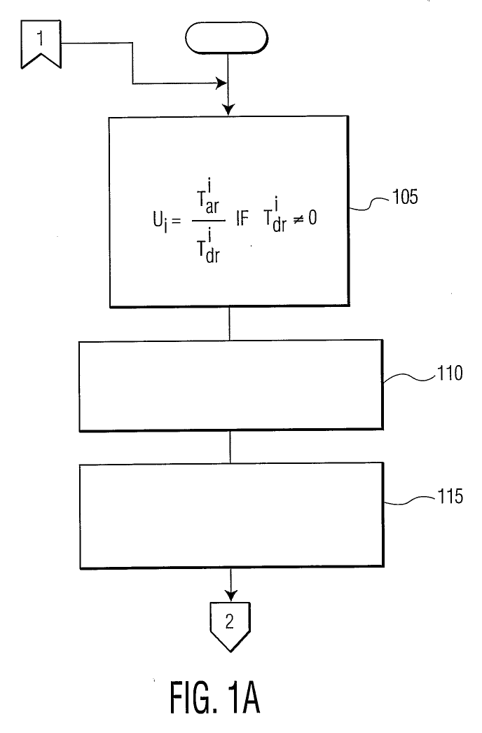

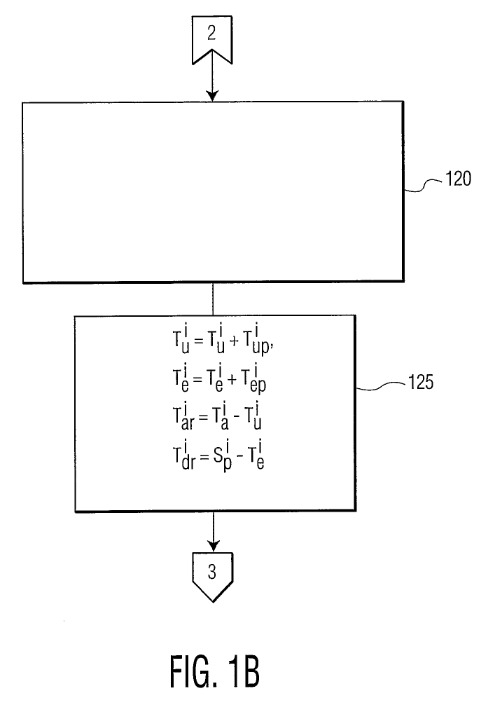

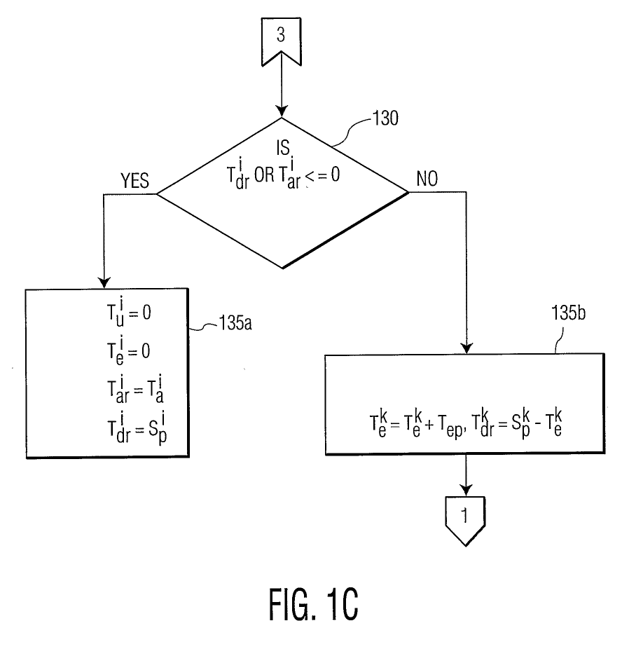

FIGS. 1A, 1B and 1C are a flowchart illustration of one aspect of the present invention.

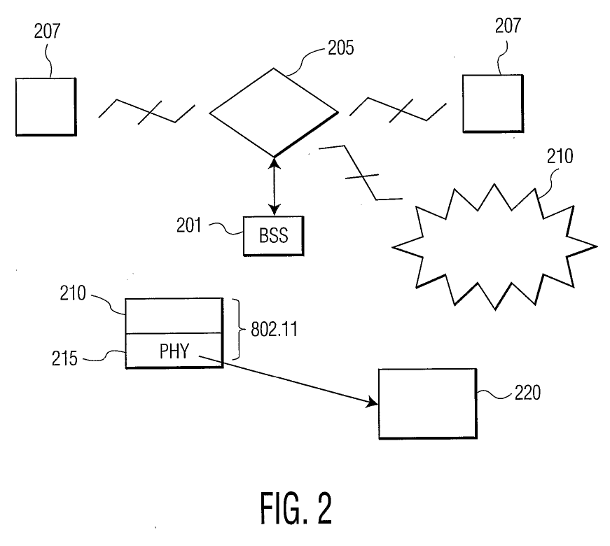

FIG. 2 is an illustration of a system utilizing the resource allocation according to the present invention.

In the following description of the invention, it should be noted that the description and accompanying illustrations are provided for purposes of illustration, and not are intended in any way, shape or form to limit the scope of the claimed invention. For example, while 802.11e is specified as one type of wireless communication that would benefit from the invention, the claimed invention can be practiced with virtually all other types of wireless communication, such as DECT, Bluetooth, wireless Ethernet, etc.

FIGS. 1A, 1B and 1C comprise a flowchart illustrating one aspect of the operation of the present invention. Prior to examining the flowchart, the following abbreviations are defined:

Sₚⁱ stands for the initial Service Period as determined by the minimum of Delay Bound or the Maximum Service Interval for traffic stream i;

Tₐⁱ is the total time allocated during the Sₚⁱ;

Tᵤⁱ is the time used during the Sₚⁱ, with an initial value=0;

Tₑⁱ is the time elapsed after the beginning of Sₚⁱ, with an initial value=0;

Tᵤⁱ=ᵣTⁱᵤ−Tᵤⁱ, which is equal to the remaining time to be allocated;

T_{d}ⁱ=ᵣSⁱₚ−Tₑⁱ, which is the time remaining before the service period Sₚⁱ elapses; and

N is equal to the number of all traffic streams or traffic categories to be served.

Each of the above parameters are associated with one stream, and the service transmission of one of the packets belonging to that one stream.

At step 105, for each particular traffic stream “i” or traffic category “i” a factor Uᵢ is initially calculated, wherein

$${U}_{i} = \frac{{T}_{ar}^{i}}{{T}_{dr}^{i}} if {T}_{dr}^{i} \neq 0 ,$$

otherwise Uᵢ=1.

At step 110, Pick Uᵢ|Uᵢ [symbol] Uₚ for all p,p=1 . . . N. In other words, the Uᵢ picked is the maximum of all Uᵢ's calculated in step 105.

At step 115, the traffic stream or category “i” is served. In other words, a packet from the head of the queue for traffic category “i” is picked to be transmitted over the channel. The channel time used in attempts to transmit this packet, whether the attempts are successful or not, is obtained and it is referred to as Tᵤₚⁱ. This parameter can be easily obtained, for example, by keeping track of the time it was first transmitted on the channel and the time an acknowledgement was received. Furthermore, some MAC layer overheads could be included in this parameter depending on the specifics of the protocol. Similarly, the total time elapsed since the parameter Tₑⁱ of this stream (i) was last updated could be easily obtained by keeping track of the time elapsed since the last time.

At step 120, at the end of the transmitted packet in step 115, there is a retrieving of Tᵤₚⁱ, which is the time used for the transmission of the packet serviced in step 115. In addition to retrieving Tᵤₚⁱ, Tₑₚ is also retrieved, with Tₑₚ being a time elapsed since a last packet was transmitted (meaning a previous packet prior to said this stream packet “i”).

At step 125 update values of Tᵤⁱ by the equation of Tᵤⁱ+Tᵤₚⁱ;

In addition, update Tₑⁱ=Tₑⁱ+Tₑₚ, as well as Tₐⁱ=ᵣTₐⁱ−Tᵤⁱ and
T_{d}ⁱ=ᵣSₚ^{o}−Tₑⁱ for the current stream “i”.

At step 130, there is a determination made as to whether T_{dr}ⁱ or Tₐᵣⁱ<=0 for the stream “i”. If either T_{dr}ⁱ or Tₐᵣⁱ is less than or equal to 0, for the current stream “i”, then at step 135a update:
Tᵤⁱ=0, Tₑⁱ=0, Tₐᵣⁱ=Tₐⁱ, and T_{dr}ⁱ=Sₚⁱ.

Unconditionally, for streams other than the current “i”, at step 135b update:
Tₑ^{k}=Tₑ^{k}+Tₑₚ, T_{dr}^{k}=Sₚ^{k}−Tₑ^{k}.

Then the method goes back to step 105 and repeats until the service interval is complete, or until there are no more streams requiring service.

FIG. 2 illustrates an example of hardware (and software) for providing a scheduling system that adjusts scheduling by a fraction of remaining time to be allocated over a remaining service interval.

A typical WLAN comprises a Basic Service Set (BSS) 201, having an Access Point (AP) 205, and a plurality of nodes 207. At least one other wireless network 210 can also communicate with the nodes via the AP 205. The AP 205 contains, among other items, a data link layer 210 and a PHY link layer. The two layers are largely responsible for the communication protocol of the WLAN. While the example shows 802.11 as the wireless protocol, it should be understood that other wireless protocols can be used with the present invention, including Bluetooth, DECT, wireless Ethernet, wireless TCP/IP, etc., and the invention is also applicable for use with wired networks.

A fairness module 220 is contained within, or is in communication with, the PHY 215 and data link layer. The fairness module can include a computer readable medium that executes the management of resource allocation according to the present invention.

The fairness module 220 controls the bandwidth allocation while considering changes in the channel PHY rate vary over time and for each node/station so that the QoS requirements of all the packet streams are not violated. According to an aspect of the present invention, with respect to a minimum of a Delay Bound or a Maximum Service interval for a traffic stream is allocated to a stream with the highest ratio of the remaining channel time to be allocated in a service period Sₚ to the remaining time is to be serviced first before the service period Sₚ elapses.

Various modifications may be made to the present invention that are clearly within the spirit of the invention and the scope of the appended claims. For example, the communication protocol can be of a type other than mentioned in the specification, so long as there is a service period or equivalent that must be allocated among a plurality of users.

What is claimed is:

1. A method of scheduling by a fraction of remaining time to be allocated over a remaining service interval in a communication protocol, said method including the steps of:
(a) determining a stream “i” with a highest ratio of time remaining to be allocated in a Service Period Sₚ to a remainder of time before the service period Sₚ elapses; and
(b) servicing the stream “i” determined in step (a) first relative to at least one other stream.

2. The method according to claim 1, wherein step (a) includes:
(i) obtain a factor Uᵢ for each particular traffic stream i of a plurality of traffic streams (s105), wherein
$${U}_{i} = \frac{{T}_{ar}^{i}}{{T}_{dr}^{i}} if {T}_{dr}^{i} \neq 0 ,$$
otherwise Uᵢ=1, wherein Tₐᵣⁱ is equal to remaining time to be allocated, and T_{dr}ⁱ is equal to time before an initial Service period Sₚⁱ expires comprising at least one of a Delay Bound and a Maximum Service Interval elapses
(ii) select a particular U, factor obtained in step (i) that has a maximum value of the plurality of streams (s110);
(iii) service the particular stream selected in step (ii) (s115);
(iv) retrieve a time used Tᵤₚⁱ to transmit the particular stream “i” serviced in step (iii), wherein a serviced stream comprises a transmission of one or more packets belonging to the particular stream (s120) and retrieve Tₑₚ with Tₑₚ being a time elapsed since a previous packet was transmitted; and
(v) update Tₑⁱ=Tₑⁱ+Tₑₚ, as well as Tₐⁱ=ᵣTⁱₐ−Tᵤⁱ and
T_{d}ⁱ=ᵣSⁱₚ−Tₑⁱ for the current stream “i” (s125);
(vi) determine whether T_{dr} or Tₐᵣ<=0 for the stream “i”, and if either of T_{dr}ⁱ or Tₐᵣⁱ is less than or equal to 0 for the current stream “i” (s130), then update:
Tᵤⁱ=0, Tₑⁱ=0, Tₐᵣ=Tₐⁱ, and T_{dr}=Sₚⁱ (s135a), whereas unconditionally, for streams other than the current “i” update:
Tₑ^{k}=Tₑ^{k}+Tₑₚ, T_{dr}^{k}=Sₚ^{l}−Tₑ^{k} (s135b).

3. The method according to claim 2, further comprising the steps of:
(vii) return to step (ii) and repeat until all of the particular traffic streams are serviced.

4. The method according to claim 1, wherein the communication protocol comprises a wireless network.

5. The method according to claim 4, wherein the wireless network operates under IEEE 802.11 protocol.

6. The method according to claim 1, wherein the servicing of the stream in step (b) includes providing a channel access to the stream “i”.

7. A computer program recorded on a computer readable medium that when operated by a computed performs the following steps:
(a) determining a stream “i” with a highest ratio of time remaining to be allocated in a Service Period Sₚ to a remainder of time before the service period Sₚ elapses of a communication network, and
(b) servicing the stream “i” determined in step (a) first relative to at least one other stream.

8. The computer program according to claim 7, further comprising:
(i) for each particular traffic stream “i” or traffic category “i” calculate a factor Uᵢ of a plurality of traffic streams, wherein
$${U}_{i} = \frac{{T}_{ar}^{i}}{{T}_{dr}^{i}} if {T}_{dr}^{i} \neq 0 ( s 105 ) ,$$
otherwise Uᵢ=1, wherein Tₐᵣⁱ is equal to remaining time to be allocated, and T_{dr}ⁱ is equal to time before an initial Service period Sₚⁱ comprising at least one of a Delay Bound and a Maximum Service Interval elapses;
(ii) select a particular Uᵢ factor obtained in step (i) that has a maximum value of the plurality of streams (s110);
(iii) service the particular stream selected in step (ii) (s115);
(iv) retrieve a time used Tᵤₚⁱ to transmit the particular stream “i” serviced in step (iii), wherein a serviced stream comprises a transmission of one or more packets belonging to the particular stream, and retrieve Tₑₚ, with Tₑₚ being a time elapsed since a previous packet was transmitted (s120); and
(v) update Tₑⁱ=Tₑⁱ+Tₑₚ, as well as Tₐⁱ=ᵣTⁱₐ−Tᵤⁱ and
T_{d}ⁱ=ᵣSₚⁱ−Tₑⁱ for the current stream “i” (s125);
(vi) determine whether T_{dr}ⁱ or Tₐᵣⁱ<=0 for the stream “i” (s130), and if either of T_{dr}ⁱ or Tₐᵣⁱ is less than or equal to 0, then update:
Tᵤⁱ=0, Tₑⁱ=0, Tₐᵣⁱ=Tₐⁱ, and T_{dr}ⁱ=Sₚⁱ (s135a); and
wherein unconditionally, for streams other than the current “i” update:
Tₑ^{k}=Tₑ^{k}+Tₑₚ, T_{dr}^{k}=Sₚ^{k}−Tₑ^{k} (s135b);
wherein Sₚⁱ stands for the initial Service Period as determined by the minimum of Delay Bound or the Maximum Service Interval for traffic stream i;
Tₐⁱ is the total time allocated during the Sₚⁱ;
Tᵤⁱ is the time used during the Sₚⁱ, with an initial value=0;
Tₑⁱ is the time elapsed after the beginning of Sₚⁱ, with an initial value=0;
Tₐⁱ=ᵣTⁱₐ−Tᵤⁱ, which is equal to the remaining time to be allocated;
T_{d}ⁱ=ᵣSⁱₚ−Tₑⁱ, which is the time remaining before the service period Sₚⁱ elapses; and
N is equal to the number of all traffic streams or traffic categories to be served.

9. The program according to claim 8, further comprising:
(vii) return to step (ii) and repeat until all of the particular traffic streams are serviced.

10. The computer program according to claim 9, further comprising:
(vii) return to step (ii) and repeat until one of (1) all of the particular traffic streams are serviced, and (2) until a service interval is complete.

11. The computer program according to claim 7, wherein the communication network comprises a wireless network.

12. The computer program according to claim 11, wherein the wireless network operates under IEEE 802.11 protocol.

13. The computer program according to claim 7, wherein the servicing of the stream in step (b) includes providing a channel access to the stream “i”.

14. An apparatus for scheduling resource allocation in a communication network, comprising:
an Access Point 205 adapted for receiving and transmitting communication from a plurality of nodes 207;
a data link 210 and physical (PHY) layer 215 adapted for providing a communication protocol; and
a fairness module 220 in communication with the at least the PHY layer, the PHY layer controlling bandwidth allocation while considering changes in a PHY transmission rate over time and for each node in communication with said Access Point 205 according to a node having a stream with a highest ratio of time remaining to be allocated in a Service Period Sₚ to a remainder of time before the service period Sₚ elapses.

15. The apparatus according to claim 14, wherein the communication protocol comprises a wireless communication protocol.

16. The apparatus according to claim 15, wherein the wireless network operates under IEEE 802.11 protocol.

17. The apparatus according to claim 14, wherein the fairness module is adapted for controlling a channel access of the plurality of the nodes.

18. The apparatus according to claim 15, wherein the wireless communication protocol comprises a Bluetooth network.

19. The apparatus according to claim 15, wherein the wireless communication protocol comprises a DECT network.

20. The apparatus according to claim 15, wherein the wireless communication protocol comprises a wireless Internet network.
